(19) United States
(12) Patent Application Publication
(10) Pub. No.: US 2008/0066310 A1
(43) Pub. Date: Mar. 20, 2008

(54) Setting stones in the surface of electroformed piece

(76) Inventor: Siu Chung Pang, Hong Kong (CN)

Correspondence Address: Alix, Yale & Ristas, LLP, 750 Main Street, Hasrtford, CT, 06103, US

(21) Appl. No.: 11/515,538

(22) Filed: Sep. 5, 2006

(51) Int. Cl. A44C 27/00; B23P 25/00

(52) U.S. Cl. 29/896.4; 29/458

(57) ABSTRACT

A method for setting at least one stone (4) in the surface of a jewelry and/or sculpture produced by electroforming comprising: a wax mandrel (1) which has a particularly designed tubular seat (5) and setting means (7, 8, 9). The wax mandrel (1) is then thoroughly painted with conductive coating (3) on its surface for conducting electricity. The stone (4) is then put in said tubular seat (5). During electroforming process, electroforming metal is deposited on said conductive coating (3) layer by layer and fills the gap between the stone (4) and the inlay position thus holds and sets the stone (4) in position. After electroforming, any redundant metal flake is removed by a scraper. Finally, said wax mandrel (1) and said conductive coating (3) are removed thermally and chemically. The method does not need to pre-set the stone (4) on a metal piece before electroforming, therefore the processing is simplified and thus greatly reduces the cost.

### FIELD OF THE INVENTION

The present invention relates to the method for the setting of precious, semiprecious or synthetic stones into the surface of an electroformed piece and, more particularly, to the structural design of the specified inlay position in the wax mandrel for these stones setting.

### BACKGROUND OF THE INVENTION

Nowadays, there are three ways to set stones into electroformed pieces. They are:

1. To pre-set the stone on a metal piece, then insert the metal piece into the electroformed piece and fix the metal piece on the electroformed piece by laser welding, by flame welding or by mechanical clamping.

2. To use glue to fix the stone directly on the surface of the electroformed piece.

3. To insert a metal piece pre-set with stone into a wax mandrel which is to be electroformed. The wax mandrel has been pre-painted with a layer of conductive coating. The surface of the wax mandrel thus becomes electrically conductive. Consequently, the wax mandrel can be electroformed with the metal piece (pre-set the stone). Therefore after electroforming, the electroformed metal layer on the wax mandrel will be integrated with the metal piece to achieve an effect wherein the stone is set firmly on said electroformed piece.

U.S. Pat. No. 6,212,745 disclosed a method for setting stones in the surface of an electroformed piece without pre-setting the stone in a metal piece. However, the method of U.S. Pat. No. 6,212,745 may exhibit the following deficiencies:

(a) Its mandrel is comprised of tin metal so that it is not easy to be produced and to be extracted.

(b) Two copper protective coatings and one thin gold layer should be additionally plated on the tin mandrel; thus its process is time-consuming, not economical and not simplified.

(c) To enable the gold electroforming to reach the space between the stone and seat bottom, some passages are provided perpendicular to each seat. Therefore, it creates difficulty in a tiny electroformed piece. Moreover, the seat of the stone is closed for light to enter the stone backward and thus cannot produce extra sparkle to bounce back at the viewer.

(d) The stone setting effect is monotonous; does not have channel setting, bezel setting.

An object of the method is to provide a unique method to set stone into electroformed piece without pre-setting stone in a metal piece.

### SUMMARY

For achieving the above mentioned object, this method preferably comprises the following steps: A stone is put in the particularly designed inlay position of the wax mandrel which has been pre-painted with a layer of conductive coating. By utilizing different shapes and dimensions of the inlay position, the stone is put in the wax mandrel handily and firmly to ensure the stone does not fall off during electroforming process. The electroforming process will deposit metal layer by layer on the conductive coating, thereby filling the gap between the stone and the inlay position which holds the stone firmly in position. Therefore, the setting effect is achieved.

The inlay technique of the stone on the metal piece and the special arrangement of electroforming process further assist the inlay.

### BRIEF DESCRIPTION OF DRAWINGS

Reference is made to the following detailed description of exemplary embodiments considered in conjunction with the accompanying drawings, in which:

FIG. 1 is a cross-sectional view, partly in diagrammatic form, of a stone setting into an electroformed piece.

FIGS. 2a, 2b and 2c are top views of a bezel setting with different shapes of stone from a top view.

FIG. 2d is a representational cross-sectional view of FIG. 2a illustrating one portion electroformed and another portion not electroformed.

FIGS. 3a, 3b and 3c are top views of a semi-bezel setting with different shapes of stone.

FIG. 3d is a cross-sectional view along the line XX of FIG. 3a.

FIGS. 4a, 4b, 4c and 4d are top views of different kinds of prong setting.

FIG. 5a is a cross-sectional view along the line YY of FIG. 4 with a tubular seat.

FIG. 5b is a cross-sectional view along the line YY of FIG. 4 without a tubular seat.

FIG. 6a is a top view of a channel setting.

FIG. 6b is a perspective view of FIG. 6a.

FIG. 7 is a cross-sectional view of a channel setting along the line ZZ of FIG. 6a.

### DETAILED DESCRIPTION OF THE PREFERRED EMBODIMENTS

In the following description, the metal used for electroforming is karat gold alloy or pure silver. The stone includes, but is not limited to, diamonds, synthetic stones, semi-precious stones or precious stones. The electroformed piece includes, but is not limited to, rings, earrings, bracelets, bangles, necklaces, pendants and brooches.

Basically, the specified inlay position design is divided into bottom layer (seat) design and surface layer design.

The bottom layer design forms a tube position for even support of the stone. The shape of the tube conforms to the shape of the stone. Commonly, the shape is circular, rectangular or square. After an electroforming process, the inner space of the tube presents a metal tubular seat which holds the stone thereon, preventing the stone from moving from front to back or left to right.

The surface layer design makes the stone receive downward pressure or transverse pressure. Thus, the stone, though without any pre-set metal piece, is securely imprisoned in the wax mandrel by downward pressure and upward support.

Since the surface of the wax mandrel has been pre-painted with a layer of conductive coating, the wax mandrel is electrically conductive. After electroforming, the contact space between the stone and the wax mandrel is filled with electroforming metal which causes the stone to be set in the surface of the electroforming metal which, in turn, achieves a prefect inlay effect. Finally, the wax and the conductive coating will be removed in order to actualize a hollow electroformed piece with a stone setting therein.

### Bottom Layer Design

Design considerations for the bottom layer are as follows:

1. The larger the size of the hollow tubular seat, the better.

Reason 1: When the size of the hollow tubular seat is larger, the larger the metal tube is as a result of the electroforming process. It means that there will be more contact points between the electroformed piece and the stone which in turn results in a firm inlay.

Reason 2: When the size of the hollow tubular seat is larger, more rays of light traverse though the stone. As a result, the stone will be glittering.

Reason 3: When the size of the hollow tubular seat is larger, the cavity of the tubular seat is bigger, which will produce advantageous conditions in the electroforming process. For example, the current and the electroforming liquid will more easily reach the inner wall of the tubular seat, which improves the quality, hardness and thickness of the metal tube. The inlay effect will be better.

2. The smaller the dimension A and angle B, the better.

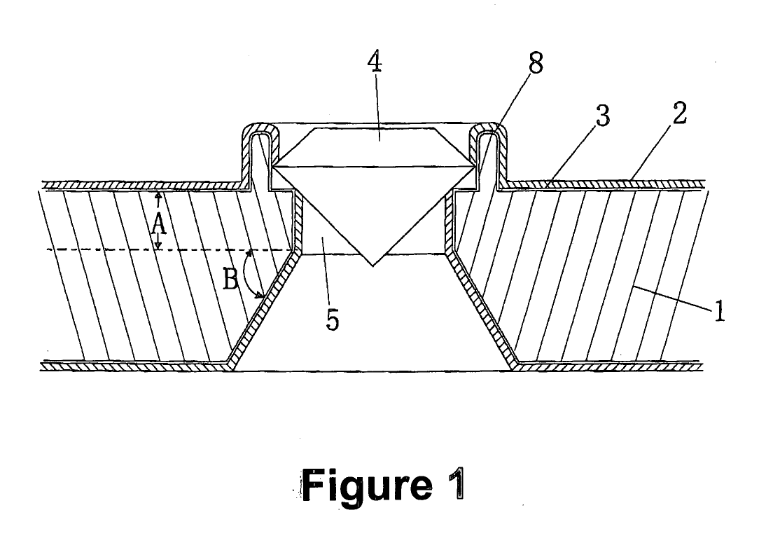

As is mentioned in Reason 3 above: When dimension A and angle B in FIG. 1 (the cross-sectional view of the stone setting into the electroformed piece) are smaller, the space adjacent the tubular seat will be wider, which produces advantageous conditions in the electroforming process. The quality, hardness and thickness of the metal tubular seat will be much improved for a better inlay effect.

In FIG. 1, 1 is the wax mandrel, 2 is the layer of electroforming metal, 3 is the layer of conductive coating, 4 is the stone, and 5 is the tubular seat.

### Surface Layer Design

The surface layer design of the wax mandrel is classified into 3 kinds:

### First Kind—Bezel or Semi-Bezel Setting

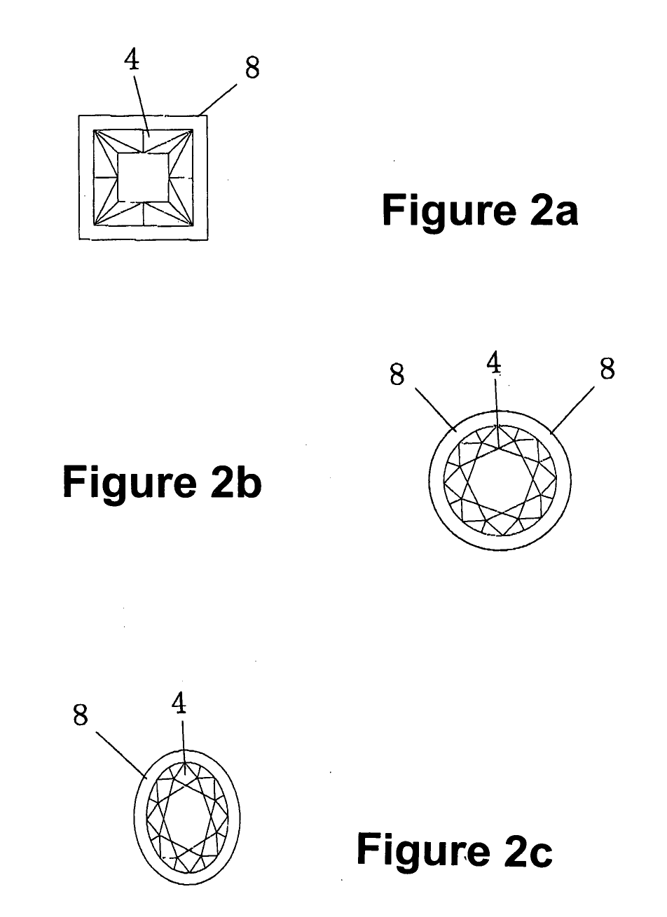

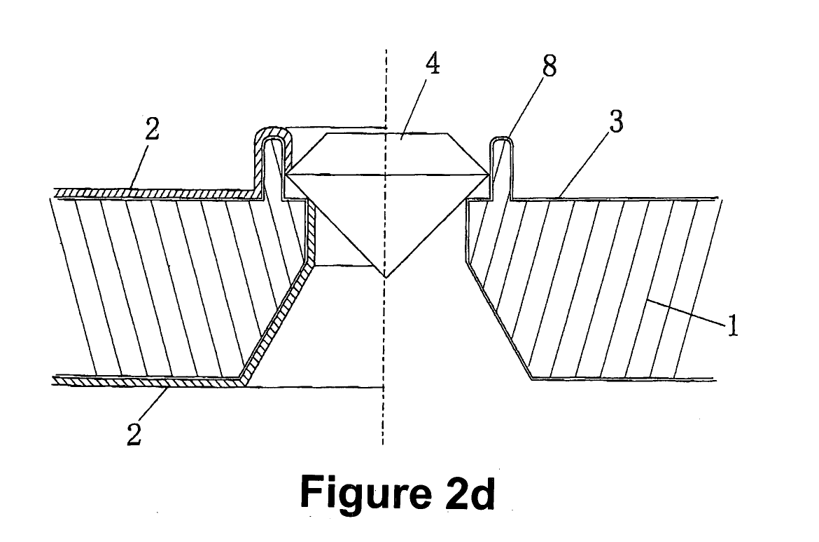

The appearance of bezel or semi-bezel setting of this invention is very much similar to the traditional one in a cast piece. The surface layer adjacent to the stone is used to form a rim that encircles the side of the stone and extends slightly above it. FIGS. 2a-c show the bezel setting with the rim entirely around different shapes of stone 4 as from the top. FIG. 2d is the cross-sectional view of FIG. 2a. In the drawings, 8 is the rim formed by the portion of surface layer 2 adjacent to the stone 4. In FIG. 2d, the right side has not been electroformed, while the left side has been electroformed.

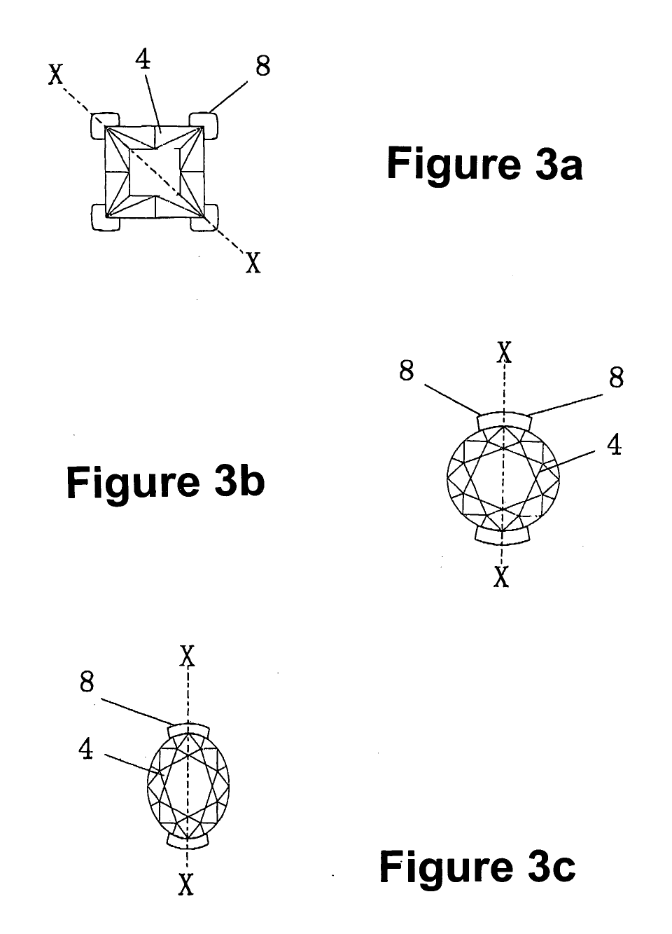

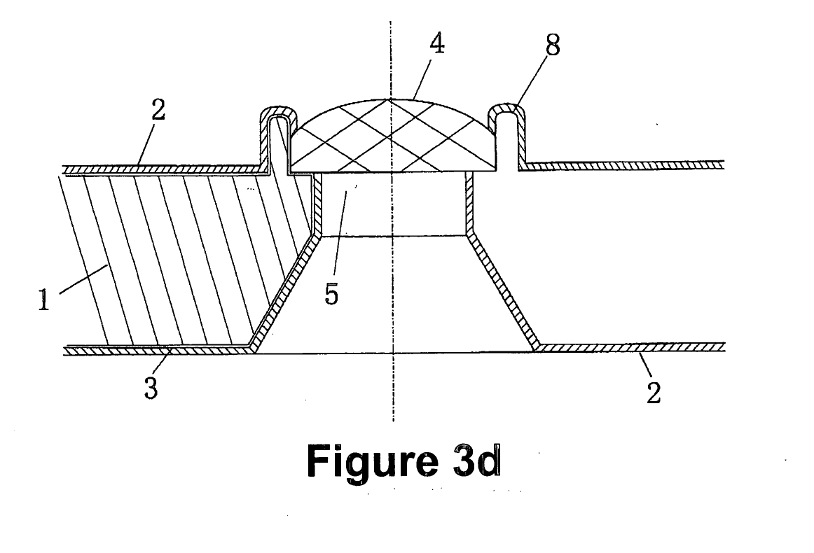

FIG. 3a shows the semi-bezel setting with the rim partially around different shapes of stone 4 viewed from the top. FIG. 3d is the cross-sectional view along the line XX of FIG. 3a. FIG. 3d shows the right side is a hollow electroformed shell with stone setting, while the left side still has wax and a conductive coating remains.

In both the bezel and semi-bezel settings, the inner dimension of the rim 8 must be exactly the same as the belt dimension of the stone 4. In doing so, when inserting the stone 4 vertically into the rim 8, the inner wall of the rim 8 will tightly fit or press against the stone 4 to prevent the stone 4 from falling off during the electroforming process.

According to the electro-physical phenomenon, numerous ions will accumulate on the sharp edge, such as rim 8. Therefore, the rim 8 will receive more deposit and become thicker, which results in a tighter inner wall of the rim 8 which is also smaller than the belt dimension of the stone 4. Finally, a transverse pressure is gradually formed, holding the stone firmly to produce a surrounding effect. When the aforesaid comes with the tubular seat of the bottom layer design (see FIG. 1, part-number 5), the stone 4 then is clamped in the rim 8 and will not move in any direction, thus achieving a perfect inlay effect.

When the inner wall of the rim 8 becomes tighter to produce a surrounding effect, the periphery of the rim 8 may bring forth a few metal flakes. Since these flakes are non-adherent to the stone, they are very easily scraped away.

### Second Kind—Prong Setting

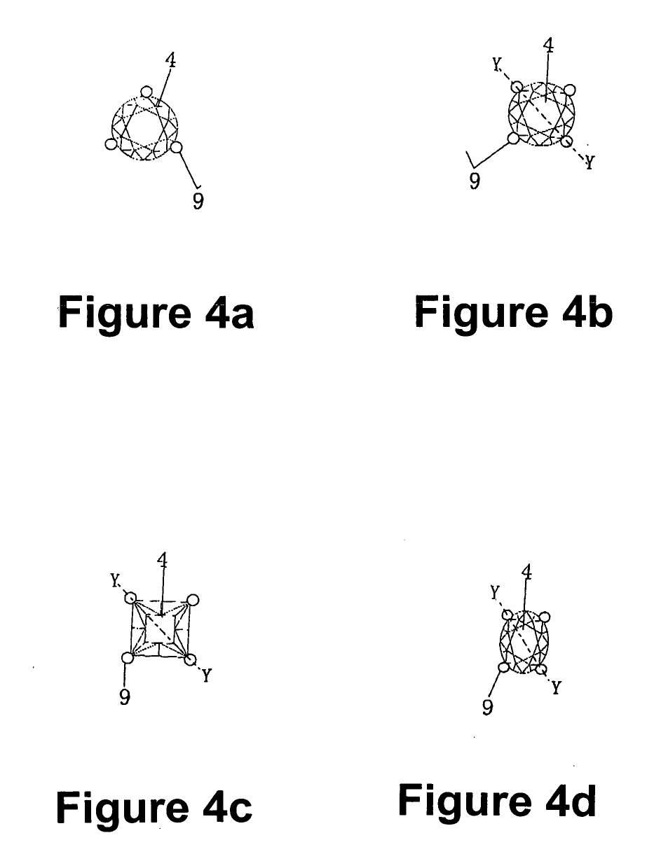

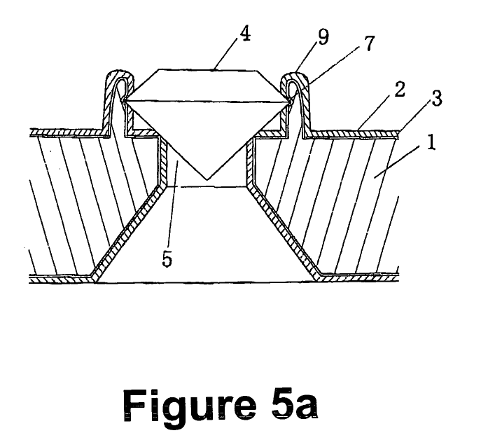

The appearance of prong setting of this invention is very much similar to the traditional prong setting in a cast piece. There are three to four pin-shaped wax pegs on the surface layer adjacent to the setting seat (FIGS. 4a-d). In FIGS. 4a-d, 4 is the stone, 9 is the wax peg. There can be more than four pegs to be used but the visual effect will not be good. It is common for four pegs to be used. The thinner the wax pegs, the better. Since thinner wax pegs produce thinner electroformed metal pegs (especially at the top of the pegs), there will be a better appearance. The height of the wax pegs must not exceed the surface of the stone 4 while it must not be lower than the widest dimension of the stone 4 (say, the belt). In FIGS. 5a and 5b, the wax peg 9 has a groove 7 on its upper portion adjacent to the belt for receiving the belt and preventing the stone 4 from falling off during electroforming process. The equal distribution of the wax pegs 9 will also be useful for surrounding the stone 4 and preventing the stone 4 from falling off.

During electroforming, metal will deposit the wax pegs and will fill the gap between the belt and the groove 7. Thus, the stone is securely clamped. With the help of the tubular seat 5 (FIG. 1) of the bottom layer design, the stone 4 will not move in any direction and is set in the electroformed piece which presents a prong setting effect.

Due to the electro-physical phenomenon, numerous ions will be located on the pegs' tips. Therefore, a large amount of electroformed metal will be deposited on the tips and make it look bulky. To compensate this blemish, the pegs are purposely designed in a conical shape

### Third Kind—Channel Setting

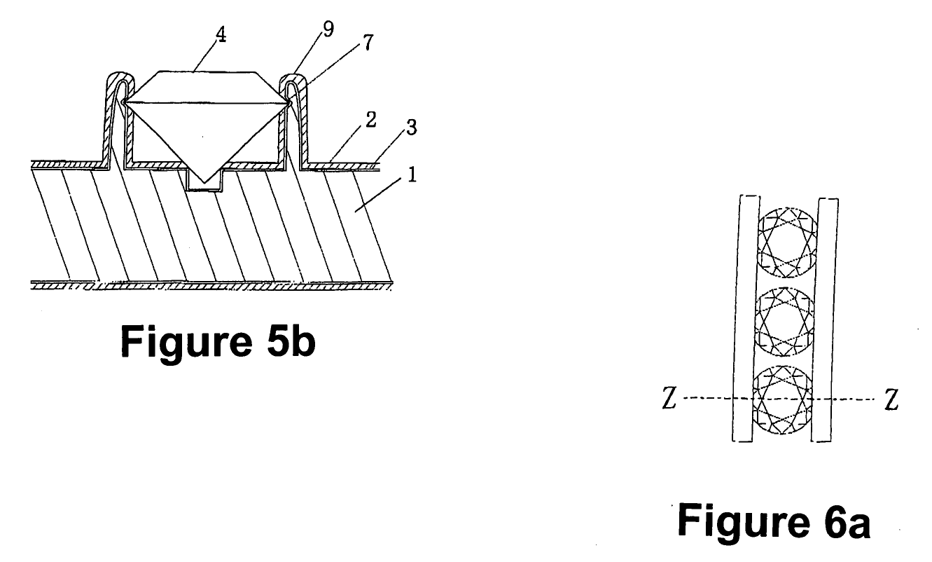

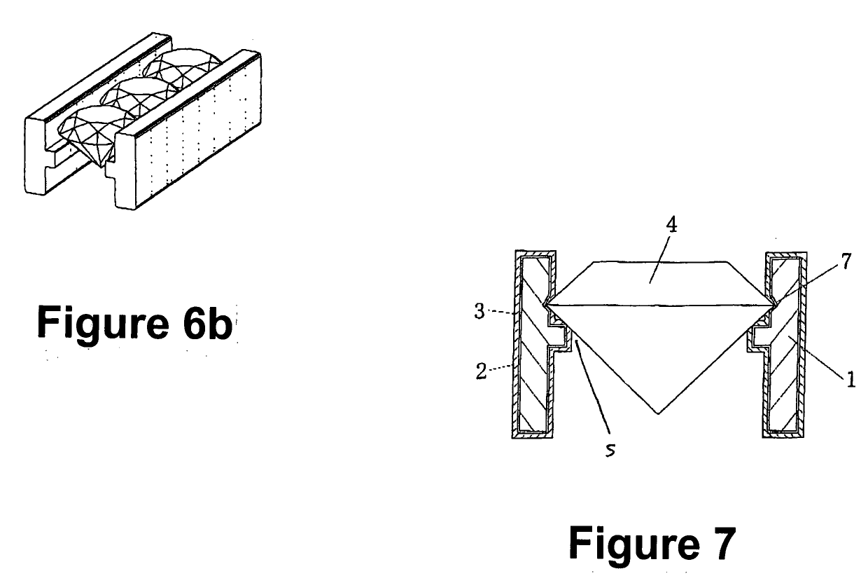

The appearance of the channel setting of one form of this method is very much similar to the traditional channel setting in a cast piece. Two or four tiny grooves 7 are put on the wax surface for buckling the belt of the stone 4 in order to hold the upper portion of the stone 4. The lower portion of the stone 4 is held by tubular seat 5 (FIG. 1). Therefore, the stone 4 will be stably stayed on the wax mandrel 1 for the electroforming process. After electroforming, the electroformed metal is deposited layer by layer and fills up the gap of the grooves 7 and presses the stone 4 in position. In addition, by using the bottom layer design of inlay seat 5 to produce a metal channel-like seat for supporting the stone 4, the stone 4 will not move in any direction and a channel setting effect is achieved. In FIG. 6a, 6b, 7, the top view, the perspective view and the cross-sectional view of a channel setting are shown respectively. The grooves are designed by 7 and 5 is the channel-like seat mentioned above.

Though no pre-set of stone is necessary, the following issues should be noted to ensure the stone 4 remains on the wax mandrel 1 during the electroforming process:

Carefully prevent any scraping on conductive coating 3, when the stone is being snappingly inserted into the inlay position. Minor scraping damage can be neglected since the electroforming metal can automatically mend minor scraping damage step by step. But for major scraping damage, after the stone 4 has been imprisoned in its position, the damage must be mended by painting thereon the conductive coating with a tiny brush.

Carefully orient the stone 4 during electroforming upwardly (not downwardly) on the wax mandrel 1 in order to prevent the stone 4 from being pulled down or loosened by gravity.

Carefully prevent electrolytic solution from being agitated too fast in the initial stage of the electroforming step. Otherwise, the stone 4 will be washed away or loosened by solution flow. Once a coating of the electroformed metal has been formed strong enough to hold the stone 4 in position, agitation can be increased. This increased agitation helps in providing a smooth or glossy finished outer surface.

The wax mandrel and the conductive coating are removed thermally and chemically to provide the finished product wherein at least one stone is set in the surface of an electroformed piece. The electroformed piece may be in the form of a sculptural work of art or a piece of jewelry such as a ring, earring, bracelet, anklet, necklace, chain pendant and breast pin. The stones may be a synthetic stone, a semi-precious stone and a precious stone such as diamond or jade. The conductive coating may be comprised of a material such as silver, brass and copper. The electroforming metal may be a gold alloy, a silver alloy, pure gold, pure silver or other metals.

Finally, the invention is not limited to the embodiments represented and described above, and it will be understood that a person skilled in the art may make many variations and modifications without departing from the spirit and scope of the invention. All such modifications and variations are intended to be included within the scope of the invention as defined in the following claims.

What is claimed:

1. A method for setting at least one stone in the surface of an electroformed piece, comprising:
providing a wax mandrel with a tubular seat and setting means;
then thoroughly painting the wax mandrel on its surface with a conductive coating for conducting electricity;
then putting the stone in said tubular seat to define an inlay position of the wax mandrel;
during an electroforming process, depositing electroforming metal on the conductive coating layer by layer, and filling a gap between the stone and the inlay position, thus holding and setting the stone in position; and
after electroforming, removing said wax mandrel and said conductive coating.

2. The method according to claim 1, further comprising employing the tubular seat at a lower portion of the stone thereon for preventing said stone from moving from a front position to a back position or from a left position to a right position.

3. The method according to claim 1, wherein said setting means comprises a continuous rim protruding from a portion of the surface of the electroformed piece adjacent to the stone, and employing the rim to surround and set the stone.

4. The method according to claim 1, wherein said setting means comprises a partial rim protruding from the portion of the surface of the electroformed piece adjacent to the stone, and employing the partial rim to surround and set the stone.

5. The method according to claim 1, wherein the stone has a belt and said setting means a plurality of pin-shaped wax column pegs on the surface of the electroformed piece adjacent to the setting seat, the said wax column pegs having grooves on the upper portion adjacent to the belt and employing the wax column pegs for receiving said belt and preventing the stone from moving during electroforming process.

6. The method according to claim 1, wherein the stone has a belt and said setting means comprises a plurality of grooves formed on a surface of the wax mandrel and employing the grooves for buckling the belt of the stone to hold the upper portion of said stone.

7. The method according to claim 1, further comprising removing any redundant metal flakes by a scraper.

8. The method according to claim 1, further comprising dimensioning the tubular seat to a substantially maximum size to accommodate the stone.

9. The method according to claim 8, wherein the stone has a belt and a top and further comprising dimensioning the height of the peg to have a height which is not to be exceeded by the top of the stone and not to be lower than the belt of the stone.

10. The method according to claim 1, wherein said stone is selected from the group consisting synthetic stone, semi-precious stone, precious stone, diamond and jade.

11. The method according to claim 1, wherein said electroformed piece is in the form of a sculptural work of art.

12. The method according to claim 1, wherein said electroformed piece is in the form of a piece of jewelry selected from the group consisting of ring, ear-ring, bracelet, wristlet, necklace, chain pendant and breastpin.

13. The method according to claim 1, wherein said conductive coating is comprised of a material selected from the group consisting of silver, brass and copper.

14. The method according to claim 1, further comprising making said wax mandrel.

15. The method according to claim 1, wherein said electroforming metal is karat gold alloy or pure silver.

16. The method according to claim 8, wherein the tubular seat has a first portion of uniform diameter and an enlarged portion which extends at angle to the first portion and further comprising dimensioning the tubular set to substantially minimize an axial length of the first portion and the angle for a given stone.
